(19) United States
(12) Patent Application Publication
(10) Pub. No.: US 2021/0126685 A1
(43) Pub. Date: Apr. 29, 2021

(54) METHOD AND APPARATUS FOR COMMUNICATION

(71) Applicant: LG ELECTRONICS INC., Seoul (KR)

(72) Inventors: Byungjin KANG, Seoul (KR); Junghyen HA, Seoul (KR); Cheolseung KIM, Seoul (KR)

(73) Assignee: LG ELECTRONICS INC., Seoul (KR)

(21) Appl. No.: 16/704,813

(22) Filed: Dec. 5, 2019

(30) Foreign Application Priority Data
Oct. 29, 2019 (KR) 10-2019-0135450

(51) Int. Cl. H04B 7/06; H04L 5/00; H04W 4/40

(52) U.S. Cl. CPC H04B 7/061; H04W 4/40; H04L 5/0048

(57) ABSTRACT

At least one of an autonomous vehicle, a user terminal, and a server may be connected or converged with an artificial intelligence (AI) module, an unmanned aerial vehicle (UAV), a robot, an augmented reality (AR) device, a virtual reality (VR) device, a device associated with a 5G service, and the like. Disclosed is a method for controlling a communication device comprising a first antenna, a second antenna, a radio frequency front end (RFFE), and a switch configured to connect an output of the RFFE and at least one of the first antenna or the second antenna, the method including identifying a switching mode regarding to transmit diversity, and, when the switching mode is a first mode, controlling the switch to connect the output of the RFFE to the first antenna and the second antenna.

### CROSS-REFERENCE TO RELATED APPLICATION

This application claims the benefit of Korean Patent Application No. 10-2019-0135450, filed on Oct. 29, 2019, in the Korean Intellectual Property Office, the disclosure of which is incorporated herein in its entirety by reference.

### BACKGROUND

### 1. Field

The present disclosure relates to a method and an apparatus for communication. One particular embodiment relates to a method and an apparatus for transmitting and receiving a signal in a communication environment using a plurality of antennas.

### 2. Description of the Related Art

With development of semi-conductor technologies and information communication technologies, various mobile electronic devices have become enabled to transmit and receive data through wireless communication. For example, a portable electronic device may transmit and receive data by communication with another device or a base station and may provide not just a voice call-related service but also a service available through data communication. In addition, through such a communication system, communication between mobile terminals may be performed, information related to driving may be exchanged between vehicles through inter-vehicle communication, and autonomous driving may be supported based on such exchanged information.

As for the mobile terminals, a surrounding environment may change due to movement of the terminal and accordingly a communication environment may change as well. Thus, there is need of a communication device capable of effectively transmitting and receiving information in such a communication environment, enhancing a communication speed, and requiring a less cost, and a method for controlling the same.

### SUMMARY

An aspect provides a method and an apparatus for effectively performing communication between mobile terminals. Another aspect provides a method and an apparatus for effectively transmitting signal in consideration of information regarding movement of a vehicle during inter-vehicle communication.

According to an aspect, there is provided a method for controlling a communication device comprising a first antenna, a second antenna, a radio frequency front end (RFFE), and a switch configured to connect an output part of the RFFE and at least one of the first antenna or the second antenna, the method including identifying a switching mode regarding to transmit diversity, and, when the switching mode is a first mode, controlling the switch to connect the output part of the RFFE to the first antenna and the second antenna.

According to another aspect, there is also provided a communication device including a first antenna, a second antenna, a radio frequency front end (RFFE) related to signal amplification, a switch configured to connect an output part of the RFFE and at least one of the first antenna or the second antenna, and a controller configured to control the RFFE and the switch. The controller may be further configured to identify a switching mode regarding transmit diversity and, when the switching mode is a first mode, the switch is controlled to connect the output part of the RFFE to the first antenna and the second antenna.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a diagram illustrating an operation of controlling a vehicle in response to information being transmitted and received between an operating device and a 5G network according to an example embodiment;

FIG. 5 is a block diagram illustrating a wireless communication system to which a method according to an example embodiment can be applied;

FIG. 6 is a diagram illustrating an example of a method of transmitting and receiving a signal in a wireless communication system according to an example embodiment;

FIG. 7 is a diagram illustrating a terminal according to an embodiment of the present disclosure.

FIG. 8 is a diagram illustrating a communication link between terminals according to an embodiment of the present disclosure.

FIG. 9 is a diagram illustrating signal transmission and reception between antennas in an inter-vehicle communication environment according to an embodiment of the present disclosure.

FIG. 10 is a diagram illustrating a terminal including a switch according to an embodiment of the present disclosure.

FIG. 11 is a diagram illustrating communication between vehicles according to an embodiment of the present disclosure.

FIG. 12 is a diagram illustrating a method for transmitting a signal in a vehicle in accordance with a communication environment according to an embodiment of the present disclosure.

FIG. 13 is a diagram illustrating a method for transmitting a signal in a vehicle in accordance with a communication environment according to another embodiment of the present disclosure.

FIG. 14 is a diagram illustrating a method for controlling signal transmission when another vehicle cuts in between vehicles, according to an embodiment of the present disclosure.

FIG. 15 is a diagram illustrating a method for transmitting a signal in response to change of a direction of driving of a vehicle according to an embodiment of the present disclosure.

FIG. 16 is a diagram illustrating a operating device according to an embodiment of the present disclosure.

### DETAILED DESCRIPTION

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus. An operation of a constituent element described as a vehicle may be performed by an operating apparatus related to the vehicle.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

At this time, an autonomous vehicle may be seen as a robot having an autonomous driving function.

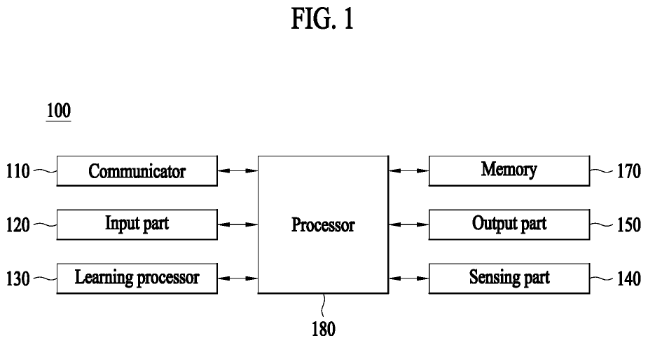

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle. The AI device may include an operating apparatus related to at least one of a vehicle or a server.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

In this case, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

In this case, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, learning processor 130 may perform AI processing along with a learning processor 240 of AI server 200.

In this case, learning processor 130 may include a memory integrated or embodied in AI device 100. Alternatively, learning processor 130 may be realized using memory 170, an external memory directly coupled to AI device 100, or a memory held in an external device. The AI device 100 may be related to the vehicle and may perform an operation required for resource management of the vehicle.

Sensing unit 140 may acquire at least one of internal information of AI device 100 and surrounding environmental information and user information of AI device 100 using various sensors.

In this case, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

In this case, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

In this case, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

In this case, processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

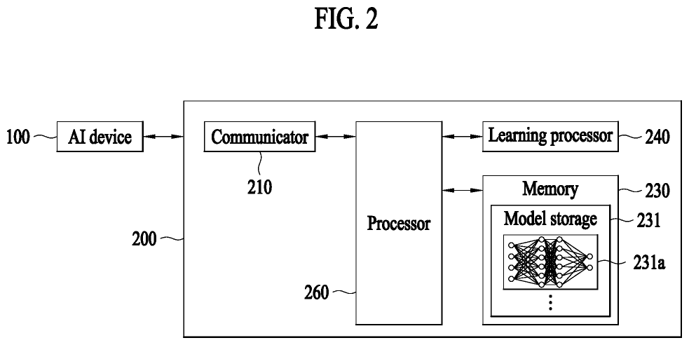

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. In this case, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

The AI server may include a server that generates a VM related to the vehicle and drives the VM. The server may perform learning based on data on generation and driving of the VM, and perform an operation to optimize such learning process.

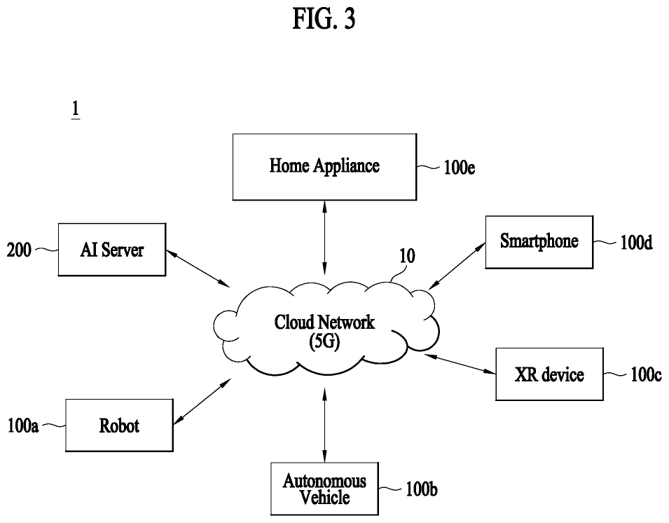

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud operating infra-structure, or may mean a network present in the cloud operating infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

In this case, instead of AI devices 100a to 100e, AI server 200 may cause an artificial neural network to learn according to a machine learning algorithm, and may directly store a learning model or may transmit the learning model to AI devices 100a to 100e.

In this case, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a specific distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

In this case, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. In this case, autonomous driving vehicle 100b may acquire interactional intention information depending on a user operation or voice expression, and may determine a response based on the acquired intention information to perform an operation.

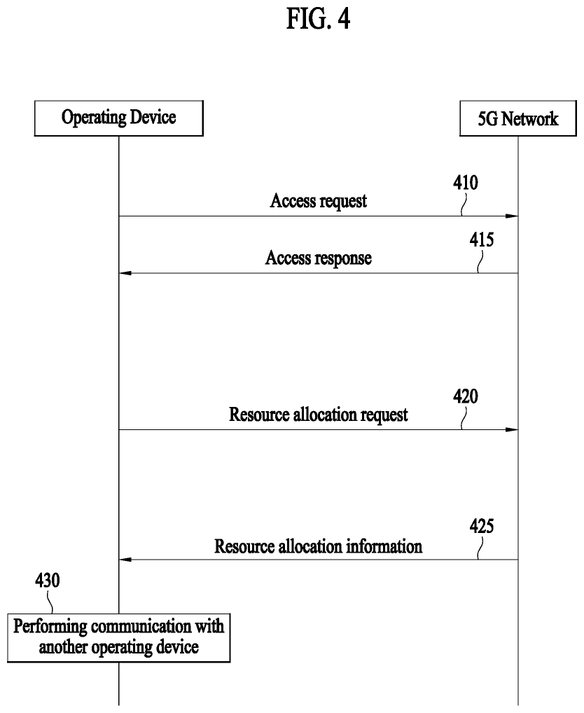

FIG. 4 is a diagram illustrating an operation of controlling a vehicle in response to information being transmitted and received between an operating device and a 5G network according to an example embodiment.

FIG. 4 illustrates a communication method performed between an operating device and a 5G network. In operation 410, the operating device may transmit an access request to the 5G network.

In operation 415, the 5G network may transmit a response to the access request to the operating device. The response to the access request, for example, an access response, may include identification information to be used when the operating device receives information. Also, the access response may include wireless resource allocation information for transmitting and receiving information of the operating device.

In operation 420, the operating device may transmit a wireless resource allocation request for communicating with another device or a base station based on the received information. The wireless resource allocation request may include at least one of information on an operating device and information on a counterpart node for performing communication.

In operation 425, the 5G network may transmit wireless resource allocation information to the operating device. The wireless resource allocation information may be determined based on at least a portion of the information transmitted in operation 420. For example, information associated with resources allocated to communicate with another operating device and identification information to be used for the corresponding communication may be included in the wireless resource allocation information. For example, communication with another operating device may be performed on a channel for device-to-device communication.

In operation 430, the operating device may perform communication with another operating device based on the received information.

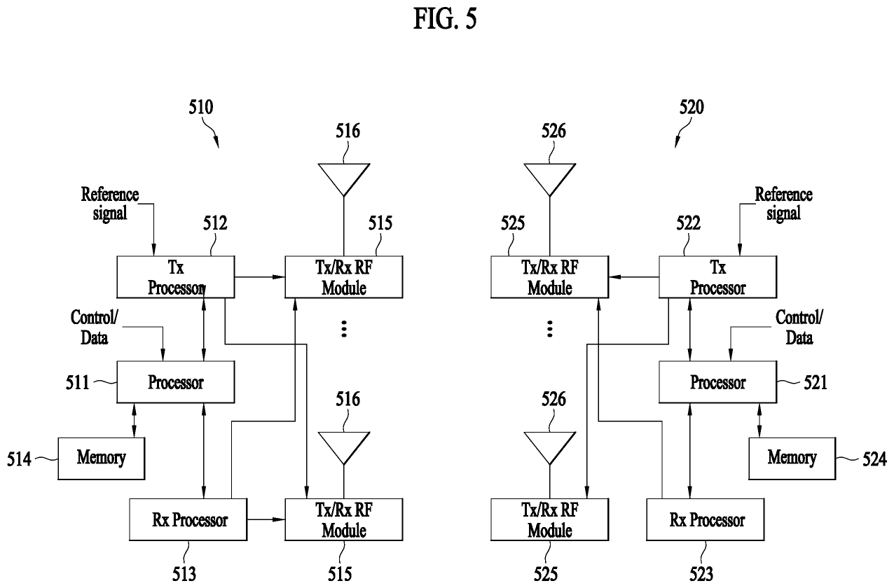

FIG. 5 is a block diagram of a wireless communication system to which a method according to an embodiment of the present disclosure can be applied.

Referring to FIG. 5, an apparatus (an autonomous driving apparatus) including an autonomous driving module may be defined as a first communication device 510, and a processor 511 may perform detailed autonomous driving operations.

A 5G network including another vehicle capable of communicating with the autonomous driving apparatus may be defined as a second communication device 520, and a processor 521 may perform detailed autonomous driving operations.

The 5G network may be expressed as a first communication device, and the autonomous driving apparatus may be expressed as a second communication device.

For example, the first communication device or the second communication device may be a base station, a network node, a Tx terminal, an Rx terminal, a wireless device, a wireless communication device, an autonomous driving apparatus, etc.

For example, a terminal or User Equipment (UE) may include a vehicle, a mobile phone, a smart phone, a laptop computer, a personal digital assistant (PDA), a portable multimedia player (PMP), a navigation, a slate PC, a tablet PC, an ultrabook, a wearable device (e.g., a smartwatch, a smart glass, a head mounted display (HMD)), etc. The HMD may be a display device which can be worn on a user's head. For example, the HMD may be used to realize virtual reality (VR), augmented reality (AR), and mixed reality (MR). Referring to FIG. 1, the first communication device 510 and the second communication device 520 includes processors 511 and 521, memories 514 and 524, one or more Tx/Rx radio frequency (RF) modules 515 and 525, Tx processors 512 and 522, Rx processors 513 and 523, and antennas 516 and 526. A Tx/Rx module may be referred to as transceivers. Each Tx/RX module transmits a signal through the antenna 526. The processor performs the above-described functions, processes, and/or methods. The processor 521 may be related to the memory 524 for storing program codes and data. The memory may be referred to as a computer readable medium. More specifically, in the DL (communication from the first communication device to the second communication), the Tx processor 512 implements various signal processing functions of L1 layer (that is, physical layer). The Rx processor implements various signal processing functions of the L1 layer (that is, physical layer).

The UL (communication from the second communication device to the first communication device) is implemented in the first communication device 510 in a manner similar to the above-description regarding receiver functions in the second communication device 520. Each Tx/Rx module 525 may receive a signal through the antenna 526. Each Tx/Rx module provides a RF subcarrier and information to the Rx processor 523. The processor 521 may be related to the memory 524 for storing program codes and data. The memory may be referred to as a computer readable medium.

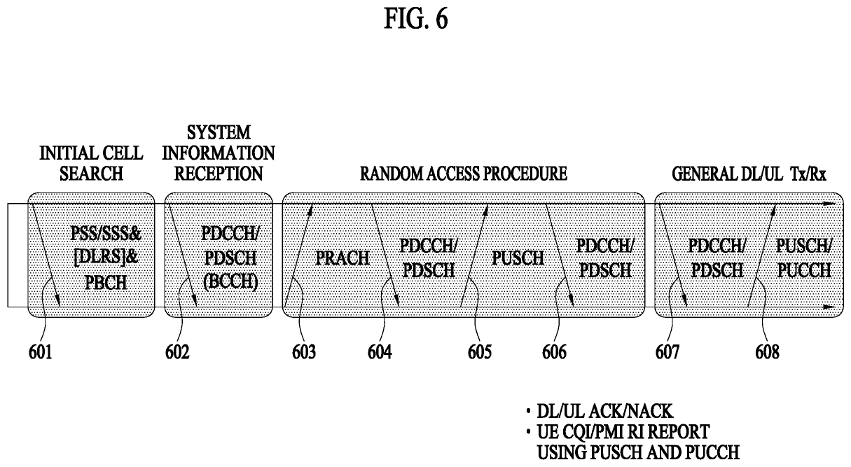

FIG. 6 is a diagram illustrating a method of transmitting and receiving a signal in a wireless communication system according to an example embodiment.

FIG. 6 illustrates an example of a signal transmission/reception method in a wireless communication system.

Referring to FIG. 6, when UE is powered on or enters a new cell, the UE may perform initial cell search such as synchronization with a BS (601). To this end, the UE may receive a primary synchronization channel (P-SCH) and a secondary synchronization channel (S-SCH) from the BS to synchronize with the BS, and may acquire information such as a cell ID. In an LTE system and an NR system, the P-SCH and the S-SCH may be called a primary synchronization signal (PSS) and a secondary synchronization signal (SSS), respectively. After the initial cell search, the UE may acquire broadcast information in the cell by receiving a physical broadcast channel (PBCH) from the BS. Meanwhile, the UE may check the state of a downlink channel by receiving a downlink reference signal (DL RS) during the initial cell search. After completing the initial cell search, the UE may acquire more specific system information by receiving a physical downlink control channel (PDCCH) and a physical downlink shared channel (PDSCH) based on information on the PDCCH (602).

When the UE initially accesses the BS or when there is no radio resource for signal transmission, the UE may perform a random access procedure (RACH) for the BS (603 to 606). To this end, the UE may transmit a specific sequence as a preamble through a physical random access channel (PRACH) (603 and 605), and may receive a random access response (RAR) message for the preamble through the PDCCH and the PDSCH (604 and 606). In the case of contention-based RACH, the UE may additionally perform a contention resolution procedure.

After performing the above-described procedure, the UE may perform, as general uplink/downlink signal transmission procedures, PDCCH/PDSCH reception (607) and physical uplink shared channel (PUSCH)/physical uplink control channel (PUCCH) transmission (208). In particular, the UE may receive downlink control information (DCI) through the PDCCH. The UE may monitor a set of PDCCH candidates at monitoring occasions which are set in one or more control element sets (CORESETs) on a serving cell according to search space configurations. The set of PDCCH candidates to be monitored by the UE may be defined in terms of search space sets, and such a search space set may be a common search space set or a UE-specified search space set. The CORESET is composed of a set of (physical) resource blocks having a time duration of 1 to 3 OFDM symbols. The network may set the UE to have multiple CORESETs. The UE may monitor PDCCH candidates in one or more search space sets. Here, monitoring may refer to attempting to decode PDCCH candidate(s) in a search space. When the UE has succeeded in decoding one of the PDCCH candidates in the search space, the UE may determine that a PDCCH has been detected in a PDCCH candidate, and may perform PDSCH reception or PUSCH transmission based on DCI on the detected PDCCH. The PDCCH may be used to schedule DL transmissions through the PDSCH and UL transmissions through the PUSCH. Here, the DCI on the PDCCH may include downlink assignment (i.e., downlink (DL) grant) including at least modulation, coding format, and resource allotment information associated with a downlink shared channel or uplink (UL) grant including modulation, coding format, and resource allotment information associated with an uplink shared channel.

Referring to FIG. 6, initial access (IA) in the 5G communication system will be further described.

The UE may perform cell search, system information acquisition, beam alignment for initial access, and DL measurement based on an SSB. The SSB may be mixed with a synchronization signal/physical broadcast channel (SS/PBCH) block.

The SSB may be composed of a PSS, an SSS, and a PBCH. The SSB may be composed of four consecutive OFDM symbols, and the PSS, PBCH, SSS/PBCH, or PBCH may be transmitted for each OFDM symbol. Each of the PSS and SSS may be composed of 1 OFDM symbol and 127 subcarriers, and the PBCH may be composed of 3 OFDM symbols and 576 subcarriers.

The cell search may refer to a procedure in which the UE acquires time/frequency synchronization of a cell and detects a cell identifier (ID) (e.g., a physical layer cell ID (PCI)) of the cell. The PSS may be used to detect a cell ID in a cell ID group, and the SSS may be used to detect the cell ID group. The PBCH may be used for SSB (time) index detection and half-frame detection.

There may be 336 cell ID groups, and three cell IDs may exist for each cell ID group. Thus, a total of 1008 cell IDs may exist. Information on a cell ID group, to which a cell ID of a cell belongs, may be provided or acquired through the SSS of the cell, and information on a cell ID among cell IDs of 336 cell ID groups may be provided or acquired through the PSS.

The SSB may be transmitted periodically based on the periodicity of the SSB. An SSB basic period assumed by the UE at the time of initial cell search may be defined as 20 ms. After the cell access, the periodicity of the SSB may be set to one of 5 ms, 10 ms, 20 ms, 40 ms, 80 ms, and 160 ms by a network (e.g., BS).

Next, acquisition of system information (SI) will be described.

The SI may include a master information block (MIB) and multiple system information blocks (SIBs). The SI other than the MIB may be referred to as remaining minimum system Information (RMSI). The MIB may include information/parameters for monitoring the PDCCH which schedules the PDSCH carrying system information block 1 (SIB1), and may be transmitted by the BS through the PBCH of the SSB. The SIB1 may include information on the availability and scheduling (e.g., a transmission period and an SI-window size) of the remaining SIBs (hereinafter, SIBx (x being an integer of 2 or more)). The SIBx may be included in an SI message and may be transmitted through the PDSCH. Each SI message may be transmitted within a time window (i.e., an SI-window) which periodically occurs.

Referring to FIG. 6, random access (RA) in the 5G communication system will be further described.

The random access may be used for various purposes. For example, the random access may be used for network initial access, handover, and UE-triggered UL data transmission. The UE may acquire UL synchronization and UL transmission resources through the random access. The random access may be classified into contention-based random access and contention-free random access. A detailed procedure for the contention-based random access is as follows.

The UE may transmit a random access preamble as an Msg1 of the random access in UL through the PRACH. Random access preamble sequences having two different lengths may be supported. A Long sequence length of 839 may be applied to a subcarrier spacing of 1.25 kHz or 5 kHz, and a short sequence length of 139 may be applied to a subcarrier spacing of 15 kHz, 30 kHz, 60 kHz, or 120 kHz.

When the BS receives the random access preamble from the UE, the BS may transmit a random access response (RAR) message (Msg2) to the UE. The PDCCH which schedules the PDSCH including the RAR may be transmitted by being CRC-masked with a random access (RA) radio network temporary identifier (RNTI) (RA-RNTI). The UE, which has detected the PDCCH masked with the RA-RNTI, may receive the RAR from the PDSCH scheduled by the DCI carried by the PDCCH. The UE may check whether random access response information for the preamble transmitted by the UE, i.e., Msg1, is in the RAR. Whether the random access response information for the Msg1 transmitted by the UE is in the RAR may be determined by whether there is a random access preamble ID for the preamble transmitted by the UE. When there is no response to the Msg1, the UE may retransmit the RACH preamble a specific number of times while performing power ramping. The UE may calculate PRACH transmission power for retransmission of the preamble based on the most recent path loss and a power ramping counter.

The UE may transmit, as an Msg3 of the random access, UL transmission through the uplink shared channel based on the random access response information. The Msg3 may include an RRC connection request and an UE identifier.

As a response to the Msg3, the network may transmit an Msg4, which may be treated as a contention resolution message in DL. By receiving the Msg4, the UE may enter an RRC-connected state.

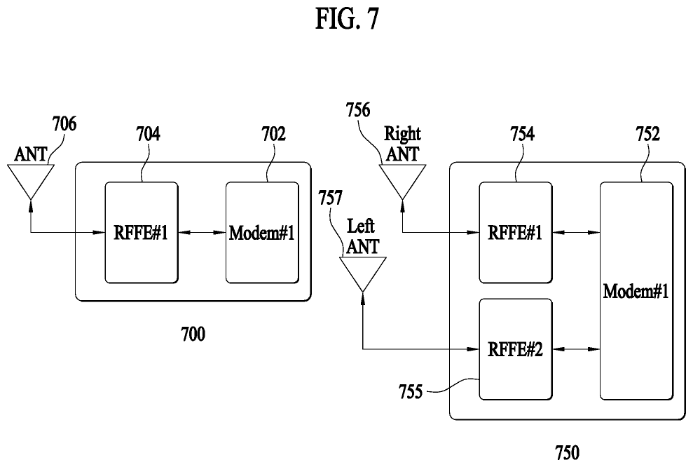

FIG. 7 is a diagram illustrating a terminal according to an embodiment of the present disclosure.

Referring to FIG. 7, a first terminal 700 capable of performing communication using a single antenna and a second terminal 750 capable of performing communication using two antennas are disclosed.

The first terminal 700 may include at least one of a modem 702, a radio frequency front end (RFFE) 704, or an antenna 706.

The modem 702 may perform overall control operation regarding communication, generate a transmission signal, and control the RFFE 704 for signal transmission.

The RFFE 704 may perform an amplifying operation a filtering operation to transmit a radio signal. In an embodiment, the RFFE 704 may include at least one of a power amplifier, a low-noise amplifier, a switch, a duplexer, or a filter, and may perform a power amplifying operation and a filtering operation for efficient signal transmission. In addition, operation of the RFFE 704 may be controlled by the modem 702. The modem 702 may control the RFFE 704 according to characteristics of a transmission signal, thereby amplifying the transmission signal while reducing power consumption. In an embodiment, the modem 702 and the RFFE 704 may be in the form of at least one processor included in a transceiver. In addition, the modem 702 and the RFFE 704 may be implemented in the same processor or may be implemented as separate processors connected to each other.

Radio signals may be transmitted and received through the antenna 706.

As such, in the case of communication between first terminals 700 each including a single antenna 706, signal transmission and reception is performed between a single transmit antenna and a single receive antenna and it is hard to expect antenna diversity and spatial multiplexing effects. Yet, such communication may be implemented using a few number of components.

The second terminal 750 may include at least one of a modem 752, a first RFFE 754, a second RFFE 755, a first antenna 756, or a second antenna 757. In an embodiment, the second terminal 750 may include two antennas, and a plurality of RFFEs corresponding to the respective antennas may be included for signal transmission of the respective antennas.

The modem 752 may perform overall control operation regarding communication, generate a transmission signal, and control the first RFFE 754 and the second RFFE 755 for signal transmission.

The first RFFE 754 and the second RFFE 755 may perform an amplifying operation and a filtering operation to transmit signals to the first antenna 756 and the second antenna 757.

As such, when communication is performed between second terminals each including a plurality of antennas, antenna diversity and spatial multiplexing effects may be achieved through multiple transmit antennas and multiple receive antennas. In addition, the communication may be performed in a transmit diversity mode in which two antennas are used to transmit one signal in accordance with a communication environment. As such, efficient communication may be performed using the second terminal 750 including the plurality of antennas.

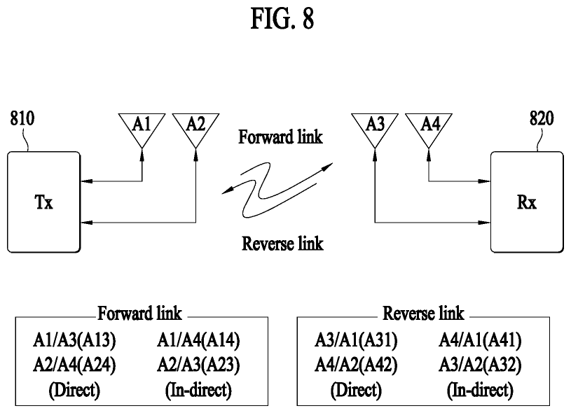

FIG. 8 is a diagram illustrating a communication link between terminals according to an embodiment of the present disclosure.

Referring to FIG. 8, information regarding signals transmitted and received between a transmitting terminal 810 and a receiving terminal 820 is illustrated.

The transmitting terminal 810 may transmit and receive signals using antennas A1 and A2, and the receiving terminal 820 may transmit and receive signals using antennas A3 and A4. Signal transmission from the transmitting terminal 810 to the receiving terminal 820 may be referred to as a forward link, and signal transmission from the receiving terminal 820 to the transmitting terminal 810 may be referred to as a reverse link.

In this case, according to a pair of a transmit antenna and a receive antenna, the forward link may correspond to signal transmission between A1 antenna and A3 antenna, between A2 antenna and A4 antenna, between A1 antenna and A4 antenna, and between A2 antenna and A3 antenna, and the reverse link may correspond to signal transmission between A3 antenna and AI antenna, between A4 antenna and A2 antenna, between A4 antenna and AI antenna, and between A3 antenna and A2 antenna.

In this case, direct communication between A1 and A3 and between A2 and A4 is enabled according to antenna arrangement. In addition, indirect communication between A1 antenna and A4 antenna and between A2 antenna and A3 antenna may be enabled. However, aspects of the present disclosure are not limited thereto, and communication between multiple transmit antennas and multiple receive antennas may be enabled using the respective antennas in accordance with a communication environment and antenna diversity and spatial multiplexing effects may be achieved.

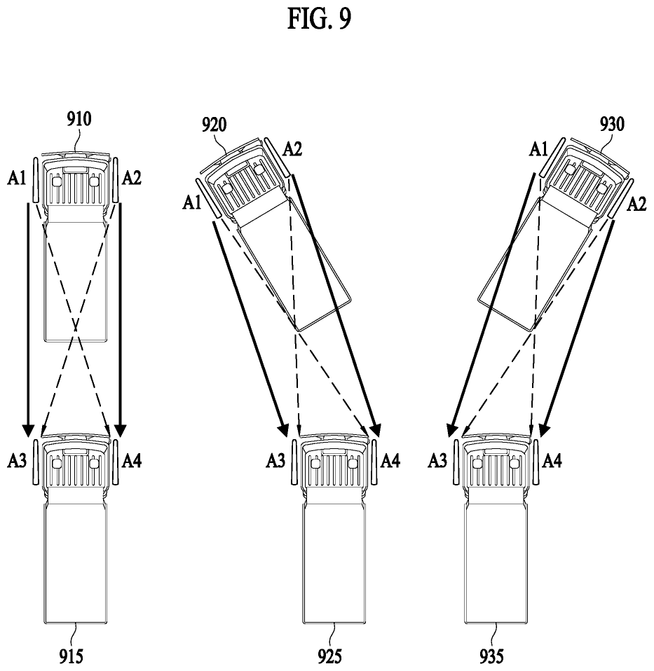

FIG. 9 is a diagram illustrating signal transmission and reception between antennas in an inter-vehicle communication environment according to an embodiment of the present disclosure.

Referring to FIG. 9, there is illustrated an environment in which two vehicles each including two antennas perform communication depending on an orientation of a leading vehicle.

First vehicles 910, 920, and 930 each includes A1 antenna and A2 antenna, and second vehicles 915, 925, and 935 each includes A3 antenna and A4 antenna.

The first vehicles 910, 920, and 930 transmit signals to the second vehicles 915, 925, and 935. In an embodiment, antennas may be installed in the left and right sides of a vehicle at locations where a line of sight (LoS) is allowed to be easily ensured to smoothly communicate with other vehicles.

When the first vehicle 910 and the second vehicle 915 drive while aligned in the same direction, each of an A1-A3 link and an A2-A4 link may secure a LoS, and signal transmission and reception may be performed through each of the A1-A3 link and the A2-A4 link. In this case, it is not possible to ensure a LoS of each of the A1-A3 link and the A2-A4 link due to the presence of the first vehicle 910. In such a communication environment, if transmit diversity is applied, more reliable communication may be enabled.

In the case where the first vehicle 920 changes a direction of driving to the left, a LoS for the A1-A3 link may not be secured in communication with the second vehicle 925, whereas a LoS for the A2-A4 link may not be secured. In addition, a LoS for A1-A4 link may be secured, whereas a LoS for A2-A3 link may not be secured. In this case, as for a signal transmitted from A2 antenna, a LoS to the second vehicle 925 may not be secured due to the presence of the first vehicle 920.

In the case where the first vehicle 930 changes a direction of driving to the right, a LoS of the A2-A4 link may be secured in communication with the second vehicle 935, whereas a LoS of the A1-A3 link may not be secured. In addition, a LoS of the A2-A3 link may be secured, whereas a LoS of the A1-A4 link may not be secured. In this case, as for a signal transmitted from AI antenna, a LoS to the second vehicle 935 due to the first vehicle 930 may not be secured.

As such, there may be some cases where a body of a vehicle transmitting a signal obstruct a LoS in communication with another vehicle. In this case, it is difficult for a signal from an antenna installed in one side of the vehicle in accordance with the direction of the vehicle to be transmitted to another vehicle. In response, a method for transmitting a signal will be described.

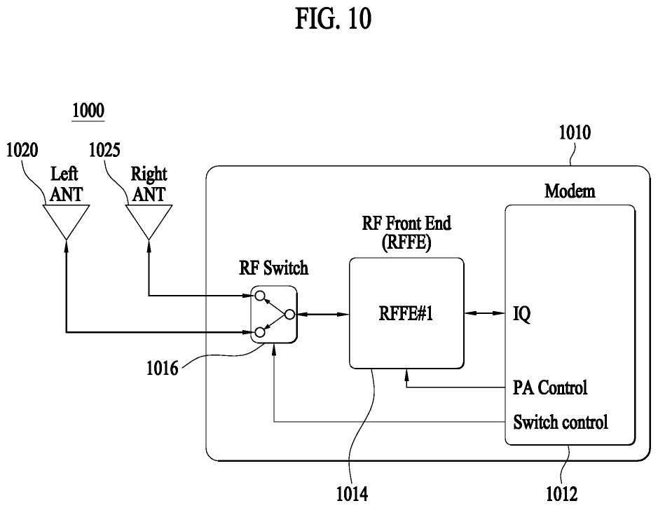

FIG. 10 is a diagram illustrating a terminal including a switch according to an embodiment of the present disclosure.

Referring to FIG. 10, a terminal 1000 according to an embodiment of the present disclosure is illustrated.

The terminal 1000 may include a signal processor 1010, and antennas 1020 and 1025 for transmitting signals generated by the signal processor and receiving a signal transmitted from another communication node.

The signal processor 1010 may include at least one of a modem 1012, an RFFE 1014, or a switch 1016. The modem 1012 may perform overall control related to communication with the terminal, transmit a transmission signal, and control the RFFE 1014 and the switch 1016 for signal transmission. More specifically, a power amplifier (PA) of the RFFE 1014 may be controlled under the control of the modem 1012. The switch 1016 may be also controlled under the control of the modem, and a signal output from the RFFE 1014 may be transmitted to at least one of the antennas 1020 and 1025.

The RFFE 1014 may perform an amplifying operation and a filtering operation to transmit a radio signal. In an embodiment, the single RFFE 1014 may be connected to a plurality of antennas 1020 and 1025 through the switch 1016. Through such connection, an imaginary/quadrature (I/Q) signal generated in the modem 1012 may be amplified by the RFFE 1014 and the amplified signal may be transmitted to at least one of the antennas 1030 and 1025 through the connection with the switch 1016. The switch 1016 may be included as an element of the RFFE 1014, and, in this case, the RFFE 1014 may include an output port corresponding to each of the antennas 1020 and 1025.

The switch 1016 may allow a signal from the RFFE 1014 to be connected to at least one of the antennas 1020 and 1025 under the control of the modem 1012.

In an embodiment, such a configuration may be used when signal transmission is performed according to transmit diversity. In the transmit diversity, signals including the same information and corresponding to each other are transmitted to both antennas. In this case, since the antennas 1020 and 1025 are connected with the RFFE 1014 through the single switch 1016, the signals may be transmitted to either or both of the antennas 1020 and 1025 depending on controlling of the switch 1016. In the above-descried transmit diversity, the switch 1016 may be connected with both of the two antennas 1020 and 1025. In addition, in the case where the switch 1016 needs to be connected with only one antenna, the switch 1016 may be controlled to transmit a signal from the RFFE 1014 to one of the two antennas 1020 and 1025.

In addition, in an embodiment, in the case where a signal is transmitted to both of the two antennas, transmit power may be degraded as the signal is branched, and thus, at least one of a method for increasing power of an I//Q signal in a modem and a method for further increasing a degree of power amplification in an RFFE may be applied. For example, as for a signal to be transmitted to both of the two antennas, 3 dB of power amplification is required compared to an existing method, and an operation associated with the power amplification may be performed by at least one of the modem 1012 or the RFFE 1014. In an embodiment, when the power amplification is performed in the RFFE, the power amplification may be performed by controlling at least one of a power amplifier module (PAM) and a radio frequency integrated circuit (RFIC) in the RFFE.

As such, in the case where an operation corresponding to transmit diversity is performed, a signal to be transmitted to two antennas is processed by a single RFFE, achieving a simpler configuration of the terminal. In addition, in the transmit diversity condition, if a signal is transmitted to an antenna on one side in accordance with a communication channel environment, the signal is transmitted to the antenna on one side, improving communication efficiency and power efficiency.

In a case where transmit diversity is applied when a leading vehicle transmits a signal to a following vehicle in communication between platooning vehicles, a signal transmitted from an antenna on one side of the following vehicle may be blocked by the body of the leading vehicle according to an arrangement relationship between the vehicles. In this case, the signal is not transmitted from the antenna on one side, and instead the signal is transmitted from an antenna on the other side, thereby improving transmission efficiency. Throughout overall embodiments, a vehicle traveling ahead may be referred to as a leading vehicle, and a vehicle traveling behind the leading vehicle may be referred to as a following vehicle.

However, the method described in the embodiments is not limited to a vehicle platooning environment, and it is apparent that the method may be applied to any other communication environment which applies transmit diversity.

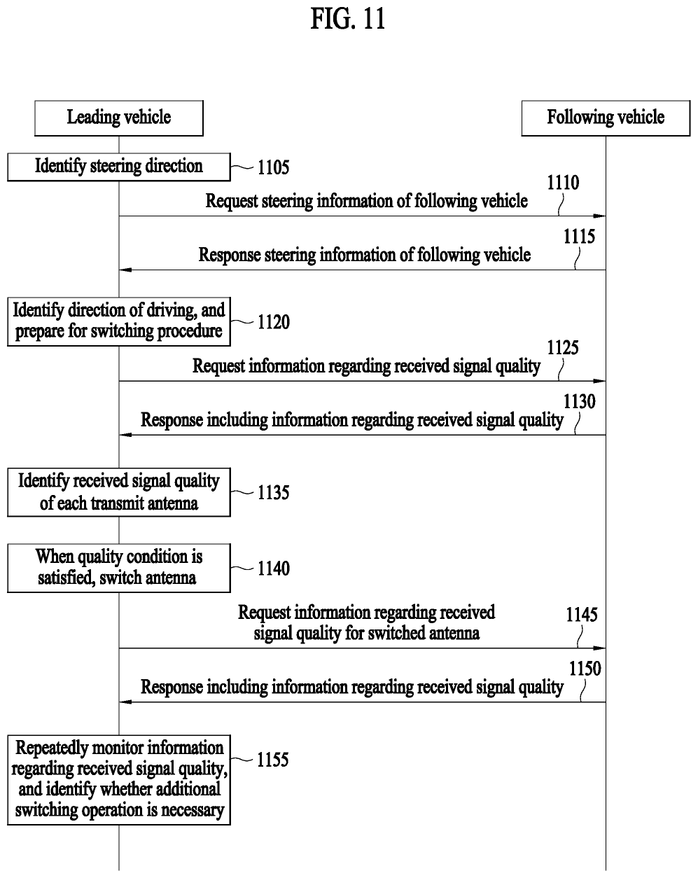

FIG. 11 is a diagram illustrating communication between vehicles according to an embodiment of the present disclosure. In the embodiment, each vehicle is capable of performing communication using two antennas, and a leading vehicle may include A1 antenna and A2 antenna. In addition, each vehicle may utilize transmit diversity for inter-vehicle communication.

Referring to FIG. 11, a method for determining a communication mode through information exchange between a leading vehicle and a following vehicle is illustrated.

In operation 1105, the leading vehicle may identify steering information thereof. In an embodiment, the steering information may include at least one operation for changing a direction of driving of the vehicle, and sensing a driver's turning the steering wheel by a specific angle or more may be identified as reception of a direction changing input. In addition, in an embodiment, the leading vehicle may identify steering information thereof, identify whether the steering information satisfies a specific condition, and perform a subsequent operation accordingly. For example, when an input for changing a direction of the vehicle to the left or right by a specific angle or more is received for more than a specific period of time, it may be identified that the steering information satisfies the specific condition. In addition, in an embodiment, the leading vehicle may identify whether the steering input satisfies the specific condition is satisfied, based on a rotational radius of the vehicle. For example, when the vehicle has a great rotational radius, there is a low possibility that communication with the following vehicle is to be interrupted due to the body of the leading vehicle. In this case, whether the steering input satisfies the specific condition may be identified in consideration of at least one of a rotational radius with respect to steering of the leading vehicle or a distance to the following vehicle. In another example, when a direction changing input is input for more than a specific time, it may be identified that steering information satisfies the specific condition.

In operation 1110, when the steering information of the leading vehicle satisfies the specific condition, the leading vehicle may request steering information of the following vehicle from the following vehicle.

In operation 1115, the following vehicle may transmit information regarding steering of the following vehicle to the leading vehicle. In an embodiment, the information transmitted to the leading vehicle may include at least one of input information regarding direction change of the following vehicle, information on a rotational radius resulting from the direction change, and information as to whether a steering-related input satisfies specific information.

In operation 1120, the leading vehicle may identify a direction of driving of the following vehicle based on the steering information of the following vehicle, and prepare for a switching procedure regarding connection of a signal from the RFFE to an antenna.

In operation 1125, the leading vehicle may request received signal quality information from the following vehicle. In the embodiment, the leading vehicle may transmit a reference signal using at least one of A1 antenna or A2 antenna and request information regarding a received signal quality from the following vehicle.

In the embodiment, the information regarding the received signal quality may include a received signal strength indicator (RSSI). In one example, a reference signal may be transmitted using each of A1 antenna and A2 antenna and may be transmitted preferentially using an antenna of a direction corresponding to steering information. For example, in the case of steering to the left, a reference signal is transmitted using A1 antenna positioned on the left side of the vehicle, and information regarding a received signal quality may be requested from the following vehicle. In an embodiment, a reference signal transmitted from each antenna may include information for identifying a corresponding transmit antenna. In an embodiment, a reference signal may include sequence information corresponding to a transmit antenna. In addition, in an embodiment, a radio resource through which a reference signal is transmitted may be a radio resource corresponding to a corresponding transmit antenna. In addition, reference signals are transmitted in a specific sequence and thus it is possible to identify an antenna through which a reference signal is transmitted from the following vehicle.

In operation 1130, the following vehicle may transmit a response message including the information regarding the received signal quality based on the received reference signal. In an embodiment, the following vehicle may transmit the information regarding the received signal quality corresponding to each antenna.

In operation 1135, the leading vehicle may identify that a channel environment using which antenna from A1 antenna and A2 antenna is good. In an embodiment, the leading vehicle may identify whether a difference between received signal qualities is greater than a specific criterion, based on a received RSSI corresponding to each of the antennas. In an embodiment, such an identifying operation may be performed in consideration of a value corresponding to a reference signal that has been transmitted from each antenna at least once. In addition, in an embodiment, an RSSI value corresponding to each of A1 antenna and A2 antenna may be reported multiple times, and a channel environment corresponding to each antenna may be identified based on a statistical value resulting from the multiple reporting. For example, an RSSI value for a signal transmitted using each antenna is received ten times or more, and a channel environment corresponding to a corresponding antenna may be identified based on an average of the received RSSI value.

In operation 1140, when a difference between RSSI values for respective antennas satisfies a preset condition, the leading vehicle may perform a switching operation to transmit a signal using an antenna of which an RSSI value is better. For example, when an RSSI value for a signal transmitted from A1 antenna is 2 dB greater than an RSSI value for a signal transmitted from A2 antenna, signal transmission is performed by switching to AI antenna. In addition, in an embodiment, other information may be exchanged between the leading vehicle and the following vehicle using the switched antenna.

In operation 1145, the leading vehicle may transmit a reference signal to the following vehicle by using the switched antenna, and request information regarding a received signal quality from the following vehicle. In an embodiment, even when for the information regarding the received signal quality is not additionally requested, the following vehicle may periodically transmit, to the leading vehicle, the information regarding the received signal quality based on the received signal.

In operation 1150, the following vehicle may transmit a response message including the information regarding the received signal quality to the leading vehicle.

In operation 1155, the leading vehicle may identify the information regarding the received signal quality of the following vehicle based on the received response message. In this case, when the identified RSSI value is lower than a reference value that is used as a basis of performing existing antenna switching, an RSSI value corresponding to an antenna in use may be periodically monitored in order to consider using two antennas again or transmitting a signal by switching to the other antenna.

As such, as an RSSI value corresponding to each antenna is monitored and switching is performed to enable using a corresponding antenna based on a result of the monitoring, effective communication may be allowed.

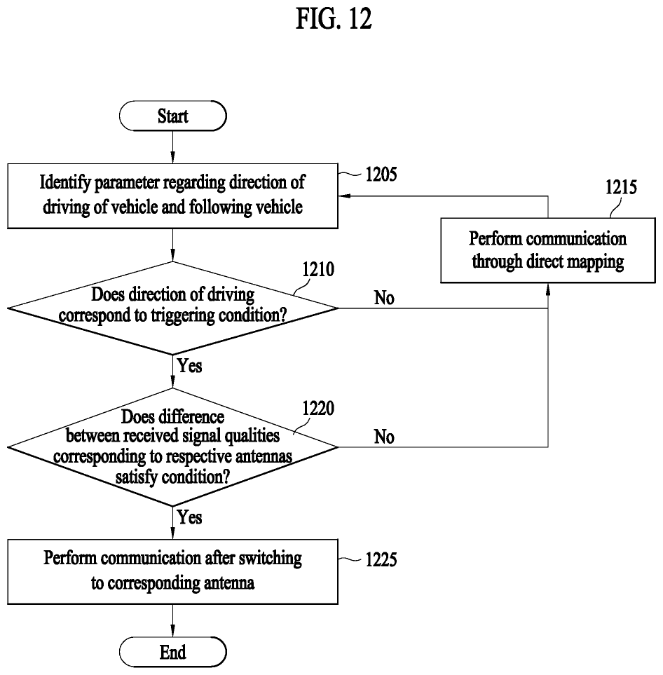

FIG. 12 is a diagram illustrating a method for transmitting a signal in a vehicle in accordance with a communication environment according to an embodiment of the present disclosure.

Referring to FIG. 12, there is illustrated a method for monitoring information regarding direction change and a channel environment in a leading vehicle and accordingly performing a switching operation to allow an antenna with a good communication environment to be used. In an embodiment, in a transmit diversity mode, a leading vehicle may generally perform communication by employing a direct mapping method in which a signal is transmitted using both two antennas.

In operation 1205, the leading vehicle may identify information on a direction of driving of the leading vehicle and information on a direction of driving of a following vehicle. For example, the leading vehicle may identify whether a direction change is made, based on at least one of a steering input, a sensing result of an acceleration sensor, or direction change information resulting from GSP sensing. In an embodiment, the acceleration sensor may include a six-component sensor and may sense whether a direction change is made, based on information on an input of a Z-axis direction orthogonal to the ground surface. In addition, the leading vehicle may request, from the following vehicle, information as to whether a direction change is made. According to an example, in the case of determining whether rotation about the Z-axis is made so as to determine whether a direction change is made, if an angle between the leading vehicle and the following vehicle is greater than a specific angle, it may be determined that a direction condition corresponds to a triggering condition. The triggering condition may differ in a curved roadway and a straight roadway. In the curved roadway, when an angle between a direction of driving of the leading vehicle and a direction of driving of the following vehicle is greater than 30 degrees, it may be determined that a direction change is made. In the straight roadway, when an angle between a direction of driving of the leading vehicle and a direction of driving of the following vehicle is greater than 15 degrees, it may be determined that there is a direction change.

In operation 1210, the leading vehicle may identify, based on acquired information, whether change of a direction of driving corresponds to a triggering condition. In an embodiment, whether the triggering condition is satisfied may be identified based on at least one of an angle by which the direction change is made or a period of time for which the direction change is maintained. For example, whether the triggering condition is satisfied may be identified based on whether a LoS between a specific antenna and the following antenna is blocked by the body of the leading vehicle.

When the triggering condition is not satisfied, the leading vehicle may continue performing communication while maintaining a direct mapping, in operation 1215.

When the triggering condition is satisfied, in operation 1220, the leading vehicle may identify whether a difference between received signal qualities corresponding to respective antennas satisfies a condition. In an embodiment, whether the difference satisfies the condition may be determined by comparing RSSI values corresponding to the respective antennas. In addition, whether the difference satisfies the condition may be determined by comparing an RSSI value for an antenna corresponding to a changed direction and an RSSI value resulting from existing direct mapping.

When the difference between the reception qualities does not satisfy the condition, the leading vehicle may continue performing communication through direct mapping, as in operation 1215.

When the difference between the reception qualities satisfies the condition, in operation 1225 the leading vehicle may perform communication by switching to a corresponding antenna. Thereafter, an RSSI value corresponding to the switched antenna may be monitored to identify whether additional switching is necessary.

As such, whether a direction change is made may be identified, and an RSSI value corresponding to each antenna with respect to the direction change is identified. When the RSSI value corresponding to each antenna satisfies a condition, communication may be performed by switching to a corresponding antenna. Accordingly, communication efficiency may be further enhanced.

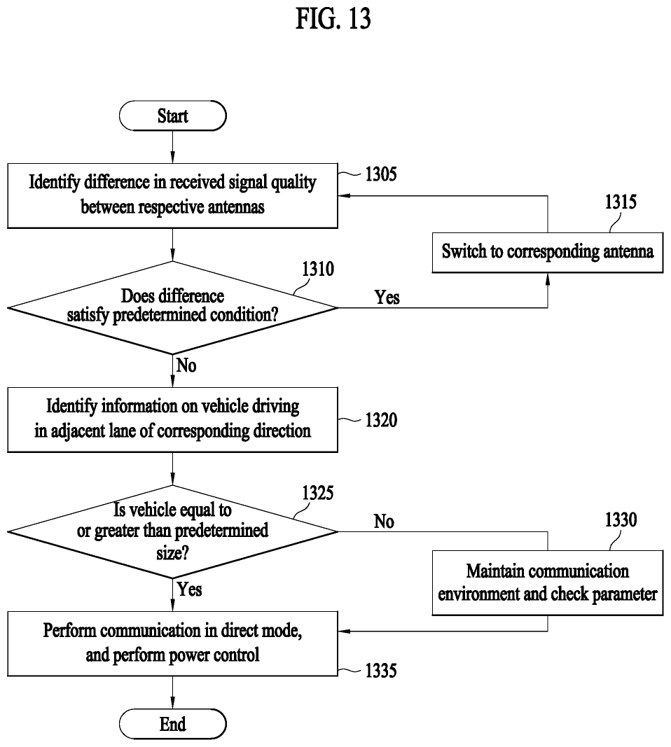

FIG. 13 is a diagram illustrating a method for transmitting a signal in a vehicle in accordance with a communication environment according to another embodiment of the present disclosure.

Referring to FIG. 13, there is illustrated an example in which a leading vehicle identifies a received signal quality of a following vehicle with respect to a transmission signal corresponding to each antenna and performs antenna switching or an additional operation depending on whether a difference between received signal qualities correspond to a specific condition.

In operation 1305, the leading vehicle may receive information regarding a received signal quality of the following vehicle with respect to a reference signal corresponding to each antenna. More specifically, an RSSI value for signal transmission corresponding to each antenna may be reported by the following vehicle. The leading vehicle may identify the reported information and compare the identified information with each other.

In operation 1310, the leading vehicle may determine, based on the identified information, whether a difference between RSSI values corresponding to respective antennas satisfies a specific condition. In an embodiment, the specific condition may include whether the difference between the RSSI values corresponding to the respective antennas correspond to 2 dB. When the difference between the RSSI values corresponding to the respective antennas corresponds to 2 dB, the leading vehicle may determine that a LoS between an antenna on one side and the following vehicle is blocked by the body of the leading vehicle in response to a direction change and then the leading vehicle may perform communication by switching to an antenna of which an RSSI value is better, in operation 1315.

Meanwhile, if there is a difference between the RSSI values but the difference does not satisfy the specific condition, the vehicle may identify information on a vehicle driving in an adjacent lane in a corresponding direction in operation 1320. In an embodiment, the corresponding direction may correspond to a direction in which an antenna having a low received signal quality is located, and the identified information on the vehicle driving in the adjacent lane may include at least one of the following: a size of the vehicle, a distance between the vehicle and the leading vehicle, a speed of the vehicle, and a shape of the vehicle.

In operation 1325, the leading vehicle may determine, based on the identified information, whether the vehicle driving in the adjacent lane is greater than a specific size. In an embodiment, whether the vehicle driving in the adjacent lane is greater than the specific size may be identified because the size of the vehicle driving in the adjacent lane affects a signal propagation environment. In addition, whether the vehicle driving in the adjacent lane affects the signal propagation environment may be identified based on the information identified above.

When the vehicle driving in the adjacent lane is greater than the specific size, the leading vehicle may, perform communication in a direct mode in operation 1335. In this case, a signal generated in a single RFFE is transmitted to two antennas, and thus, a reception quality of the transmission signal may be enhanced through power control.

When the vehicle driving in the adjacent lane is smaller than the specific size, the leading vehicle may monitor an additional communication-related parameter while maintaining a communication environment.

In an embodiment, the specific size may be included according to an element capable of affecting the signal propagation environment, and the specific size may change according to an antenna position of the leading vehicle. More specifically, if the vehicle driving in the adjacent lane is a vehicle having a size that allows the vehicle to be positioned at an antenna height or higher, it may be determined that the vehicle driving in the adjacent lane is greater than the specific size.

As such, as a control operation is performed differently depending on a difference between received signal quality and characteristics of the vehicle driving in the adjacent lane, an optimal communication environment may be provided in more diverse situations.

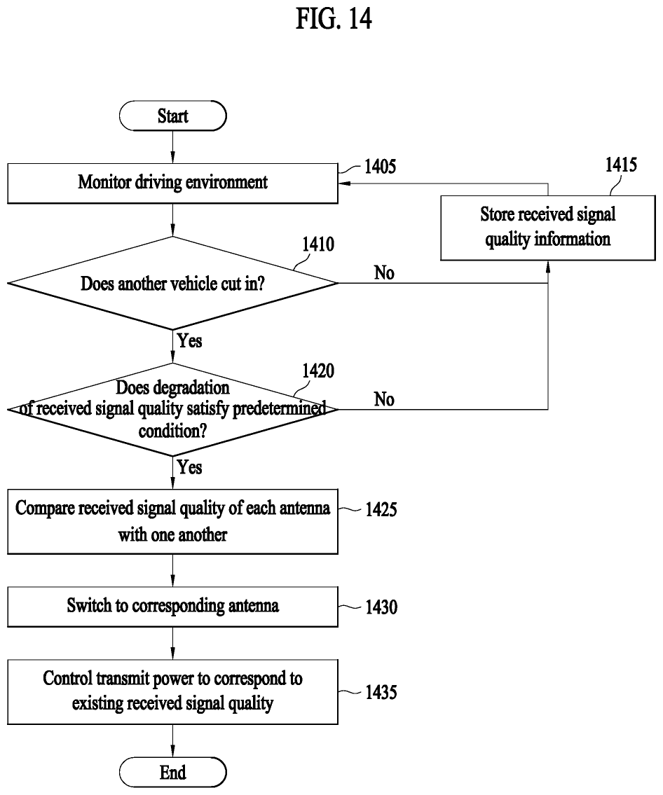

FIG. 14 is a diagram illustrating a method for controlling signal transmission when another vehicle cuts in between vehicles, according to an embodiment of the present disclosure.

Referring to FIG. 14, there is illustrated a method in which a leading vehicle monitors a driving environment regarding other vehicle including a following vehicle, identifies whether the other vehicle cuts in, and employs a different signal transmission method according to a result of the identification. In an embodiment, the leading vehicle and the following vehicle are capable of performing communication with each other and performing vehicle platooning, and the cut-in vehicle may be a vehicle not capable of performing communication with the leading vehicle and the following vehicle or may be a vehicle not performing vehicle platooning even though the vehicle is capable of performing communication.

In operation 1405, the leading vehicle may monitor information regarding a driving environment. The information regarding the driving environment to be monitored may include at least one of the following: a distance between the leading vehicle and the following vehicle, a distance between following vehicles, a speed of platooning vehicles, and a communication environment between vehicles.

In operation 1410, based on at least part of information acquired by monitoring the driving environment, the leading vehicle may identify whether the other vehicle cuts in between the platooning vehicles. In an embodiment, if at least one of a distance between the leading vehicle and the following vehicle or a distance between following vehicles increases, the leading vehicle may identify that there is a cut-in vehicle. In addition, in an embodiment, based on a communication state of at least one of the leading vehicle or the following vehicle, the leading vehicle may identify that there is a cut-in vehicle. In addition, when it is identified, based on information acquired through at least one sensor provided in the leading vehicle and the following vehicle, the other vehicle is driving between platooning vehicles, the leading vehicle may identify that there is a cut-in vehicle.

When there is no cut-in vehicle, the leading vehicle may store received signal quality information reported by the following vehicle in operation 1415. In addition, in an embodiment, the leading vehicle may identify received signal quality information based on a signal received from the following vehicle and store the identified received signal quality information. In an embodiment, when it is identified, based on the stored received signal quality information, that a communication environment changes later on, the leading vehicle may adjust transmit power to achieve a received signal quality suitable the changed communication environment.

When there is a cut-in vehicle, the leading vehicle may identify a received signal quality in operation 1420 and identify whether degradation of the received signal quality due to the cutting-in of the vehicle satisfies a specific condition. In an embodiment, when the received signal quality is degraded to be lower than a received signal quality for satisfying a specific transmission rate, the leading vehicle may determine that the degradation of the received signal quality satisfies the specific condition. When the degradation of the received signal quality does not satisfy the specific condition, the leading vehicle may store information on the received signal quality in operation 1415 and store measurement information regarding the cutting-in of the vehicle as well. As information regarding a change in the received signal quality as well as a type of the cut-in vehicle and a change in a distance between vehicles resulting from the cutting-in of the vehicle are stored, it is possible to perform a control operation regarding communication based on the stored information when a cutting-in occurs later on.

When the degradation of the received signal quality satisfies the specific condition, the leading vehicle may compare a received signal quality corresponding to each antenna to one another in operation 1425.

In operation 1430, the leading vehicle may perform a switching operation based on a result of the comparison of the received signal quality, so that a signal may be transmitted to an antenna having a more acceptable received signal quality. In an embodiment, when a difference between received signal qualities corresponding to respective antennas is greater than a specific value, the leading vehicle may perform a switching operation. In addition, in an embodiment, when the difference between received signal qualities corresponding to the both respective antennas is smaller than the specific value, the leading vehicle may transmit a signal through direct mapping.

In operation 1435, the leading vehicle may control transmit power based on the stored received signal quality information so as to maintain a received signal quality corresponding to the stored received signal quality information. For example, in the case of direct mapping, a signal generated by a single RFFE is transmitted through two antennas and thus transmit power amplification is required accordingly. In addition, even when a signal is transmitted through a single antenna, a distance between vehicles increases and it is required to amplify transmit power in order to compensate for the increase in the distance between the vehicles. The leading vehicle may amplify the transmit power to correspond to the stored received signal quality.

In addition, in an embodiment, when a cut-in vehicle cuts out, at least one of the leading vehicle or the following vehicle may identify information regarding the cutting-out of the vehicle and the leading vehicle may transmit at least one of an inter-vehicle distance or a speed to the following vehicle so as to maintain the inter-vehicle distance. Accordingly, when the inter-vehicle distance decreases, the leading vehicle may reduce transmit power and transmit the reduced transmit power to correspond to the existing received signal quality when it comes to signal transmission.

As such, when a vehicle performs vehicle platooning, the vehicle may store a received signal quality corresponding to the vehicle platooning, determine whether other vehicle cuts in, and switch a signal transmission method corresponding to the cutting-in of the other vehicle, and therefore, it is possible to enable smooth communication by maintaining the received signal quality even when a cutting-in occurs.

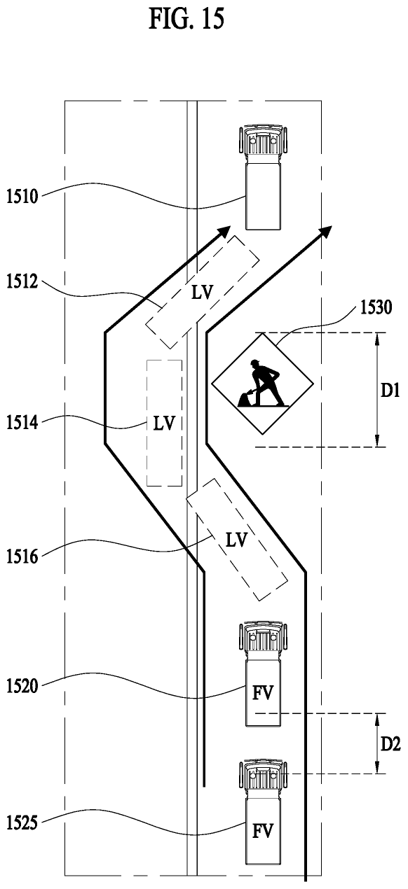

FIG. 15 is a diagram illustrating a method for transmitting a signal in response to change of a direction of driving of a vehicle according to an embodiment of the present disclosure.

Referring to FIG. 15, there is illustrated an example in which vehicles performing vehicle platooning come upon a construction area on a road and accordingly perform avoidance driving.

When a leading vehicle 1510 comes upon a construction area 1530, the leading vehicle 1510 may perform avoidance driving in a sequence of reference numerals 1516, 1514, and 1512. While avoiding the construction area, the leading vehicle 1510 may change a direction and a speed and acquire information on a distance D1 of the construction area 1530.

As such, while performing the avoidance driving, the leading vehicle 1510 may identify a received signal quality corresponding to each antenna, switch to an antenna having a more acceptable received signal quality in order to minimize a communication environment change, and perform power control in order to achieve a received signal quality corresponding to an existing received signal quality. In addition, the leading vehicle 1510 may transmit information on the construction area 1530, route information of the leading vehicle 1510, speed information of the leading vehicle 1510, or direction change information of the leading vehicle 1510 to following vehicles 1520 and 1525. In addition, when entering a lane again after avoiding the construction area 1530, the leading vehicle 1510 may transmit relevant information to the following vehicles 1520 and 1525.

In addition, the vehicles performing vehicle platooning by exchanging information as described above may exchange information so as to maintain the same distance D1 between each two of the vehicles after passing through the construction area 1530.

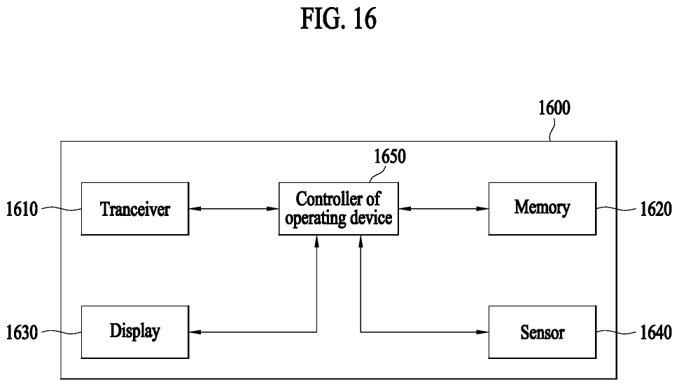

FIG. 16 is a diagram illustrating a operating device according to an embodiment of the present disclosure.

Referring to FIG. 16, a operating device 1600 according to an embodiment may include at least one of a transceiver 1610, a memory 1620, a display 1630, a sensor 1640, or a controller 1650 for controlling the operating device 1600. In an embodiment, the operating device 1600 may perform an operation related to controlling of a vehicle and may be installed in the vehicle or connected with the vehicle through wired or wireless communication.

The transceiver 1610 may communicate with at least one of another vehicle or a base station. For example, the transceiver 1610 may communicate with a camera associated with a server. In addition, in an embodiment, the transceiver 1610 may include a device for performing wireless communication.

The memory 1620 may store at least one of information transmitted and received through the transceiver 1610 or information input to the operating device 1600. Information processed through controlling of the controller 1650 or processed through an additional learning may be stored in the memory 1620 as well. The memory 1620 may include a non-volatile memory and may include a medium capable of electronically storing information.

The display 1630 may visually provide information regarding an operation of the operating device 1600. For example, when the operating device 1600 communicate with another vehicle performing vehicle platooning, information regarding the communication may be provided on the display 1630. In addition, the display 1630 may be provided with a speaker and thus provide sound information to a user.

The sensor 1640 may acquire information regarding driving of the vehicle. In an embodiment, a sensor may include at least one of a radar sensor, a lidar sensor, a proximity sensor, a global positioning system (GPS) sensor, a speed sensor, an acceleration sensor, or a camera. Through the sensor, physical information regarding driving of the vehicle may be acquired and information regarding to a vehicle adjacent to the vehicle may be acquired. For example, information such as a size, a speed, and a direction of the adjacent vehicle may be acquired through the sensor 1640.

The controller 1650 may control other constituent elements of the operating device 1600 and may include at least one processor. In an embodiment, the controller 1650 may control the operating device 1600 to perform at least one operation of the operating device 1600.

Meanwhile, a communication method according to an embodiment may be used for communication not just between vehicles but also between other terminals and it is apparent that the communication method may be applied in a corresponding manner when a communication environment changes in response to movement of a terminal. Even when the communication method is applied to a vehicle, the communication method may be applied regardless of a type of the vehicle. In addition, even when communication is performed using two or more antennas, a communication environment may be monitored and the communication method may be modified in a corresponding manner.

According to embodiments of the present disclosure, it is possible to perform communication between terminals using a communication device having a simpler structure. In addition, it is possible to bring higher communication efficiency by controlling communication based on information regarding movement of a terminal.

The terms or words described in the specification and the drawings should not be limited by a general or lexical meaning, instead should be analyzed as a meaning and a concept through which the inventor defines and describes the present disclosure to the best of his/her ability, to comply with the idea of the present disclosure. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

1. A method for controlling a communication device comprising a first antenna, a second antenna, a radio frequency front end (RFFE), and a switch configured to connect an output of the RFFE and at least one of the first antenna or the second antenna, the method comprising:
identifying a switching mode regarding to a transmit diversity; and
when the switching mode corresponds to a first mode, controlling the switch to connect the output of the RFFE to the first antenna and the second antenna, and the first antenna and the second antenna transmit a signal generated from the RFFE.

2. The method of claim 1, further comprising:
identifying first information related to a received signal quality corresponding to the first antenna;
identifying second information related to a received signal quality corresponding to the second antenna; and
when a difference between a value corresponding to the first information and a value corresponding to the second information is greater than a specific value, identifying the switching mode as a second mode.

3. The method of claim 2, further comprising, when the switching mode corresponds to the second mode, controlling the switch to connect the output of the RFFE and an antenna among the first and second antennas identified based on the first information and the second information.

4. The method of claim 2, further comprising controlling the RFFE to amplify power with a power amplification value corresponding to the first mode,
wherein the power amplification value corresponding to the first mode is greater than a power amplification value corresponding to the second mode.

5. The method of claim 1, further comprising:
transmitting a first reference signal corresponding to the first antenna;
transmitting a second reference signal corresponding to the second antenna; and
identifying the switching mode based on response information received based on at least one of the first reference signal or the second reference signal.

6. The method of claim 5, wherein the first reference signal comprises sequence information corresponding to the first antenna, and the second reference signal comprises sequence information corresponding to the second antenna.

7. The method of claim 1, further comprising:
when information related to a direction change of a vehicle related to the communication device does not correspond to a specific condition, identifying the switching mode as the first mode.

8. The method of claim 1, wherein when information related to a direction change of a vehicle related to the communication device corresponds to a specific condition and information regarding a direction change of another vehicle associated with the vehicle corresponds to the specific condition, identifying the switching mode as a second mode.

9. The method of claim 1, further comprising identifying the switching mode based on information on a vehicle adjacent to a vehicle related to the communication device.

10. A communication device, comprising:
a first antenna;
a second antenna;
a radio frequency front end (RFFE) related to signal amplification;
a switch configured to connect an output of the RFFE and at least one of the first antenna or the second antenna; and
a controller configured to:
identify a switching mode regarding transmit diversity; and
when the switching mode corresponds to a first mode, controlling the switch to connect the output of the RFFE to the first antenna and the second antenna, and the first antenna and the second antenna transmit a signal generated from the RFFE.

11. The communication device of claim 10, wherein the controller is further configured to:
identify first information regarding a received signal quality corresponding to the first antenna;
identify second information regarding a received signal quality corresponding to the second antenna; and
when a difference between a value corresponding to the first information and a value corresponding to the second information is greater than a specific value, identify the switching mode as a second mode.

12. The communication device of claim 11, wherein when the switching mode corresponds to the second mode, the controller is further configured to control the switch to connect the output of the RFFE and an antenna among the first and second antennas determined based on the first information and the second information.

13. The communication device of claim 11, wherein:
the controller is further configured to control the RFFE to amplify power with a power amplification value corresponding to the first mode, and
the power amplification value corresponding to the first mode is greater than a power amplification value corresponding to the second mode.

14. The communication device of claim 10, wherein the controller is further configured to:
transmit a first reference signal corresponding to the first antenna;
transmit a second reference signal corresponding to the second antenna; and
identify the switching mode based on response information received based on at least one of the first reference signal or the second reference signal.

15. The communication device of claim 14, wherein the first reference signal comprises sequence information corresponding to the first antenna, and the second reference signal comprises sequence information corresponding to the second antenna.

16. The communication device of claim 10, wherein, when information regarding a direction change of a vehicle related to the communication device does not correspond to a specific condition, the controller is further configured to identify the switching mode as the first mode.

17. The communication device of claim 10, wherein when information regarding a direction change of a vehicle related to the communication device corresponds to a specific condition and information regarding a direction change of another vehicle associated with the vehicle corresponds to the specific condition, the controller is further configured to identify the switching mode as a second mode.

18. The communication device of claim 10, wherein the controller is further configured to identify the switching mode based on information on a vehicle adjacent to a vehicle related to the communication device.

19. A non-volatile storage medium for storing an instruction corresponding to the method of claim 1.
